(19) United States
(12) Patent Application Publication
(10) Pub. No.: US 2010/0182126 A1
(43) Pub. Date: Jul. 22, 2010

(54) BIOMETRIC SENSING APPARATUS AND METHODS INCORPORATING THE SAME

(76) Inventors: Dinesh J. Martis, Loveland, OH (US); Sunil G. Kulkarni, Cincinnati, OH (US)

Correspondence Address: PORTER WRIGHT MORRIS & ARTHUR, LLP;INTELLECTUAL PROPERTY GROUP, 41 SOUTH HIGH STREET, 28TH FLOOR, COLUMBUS, OH, 43215, US

(21) Appl. No.: 12/642,578

(22) Filed: Dec. 18, 2009

Related U.S. Application Data
(60) Provisional application No. 61/138,809, filed on Dec. 18, 2008.

(51) Int. Cl. G06F 7/04

(52) U.S. Cl. 340/5.83; 340/5.82

(57) ABSTRACT

A sensing apparatus simultaneously and noninvasively measures on a single finger a static biometric parameter, such as a fingerprint or blood vessel pattern, and a dynamically variable parameter, such as oxygen saturation of the blood and/or pulse rate.

### RELATED APPLICATIONS

This application claims priority under 35 U.S.C. §119(e) to U.S. Provisional Application Ser. No. 61/138,809, filed Dec. 18, 2008.

### FIELD OF THE INVENTION

The invention relates generally to biometric sensors and more particularly to an apparatus for simultaneously sensing multiple biometric parameters. The invention will be specifically disclosed in connection with an apparatus for simultaneously sensing a subject's pulse, oxygen saturation and fingerprint from a finger of a subject.

### BACKGROUND OF THE INVENTION

It is well known to measure static biometric parameters of humans for purposes of identification. The static biometric parameter most commonly used for identification is a fingerprint, that is the pattern of friction ridges and depressions on the fingers or palms of a person. Fingerprints are advantageously used for identification because they are unique to an individual, and are never duplicated on another person. Further, fingerprints of an individual do not vary over time. Consequently, fingerprints of an identified individual can be recorded, and if a subsequently measured fingerprint matches the recorded fingerprint, it can be conclusively established that the matched fingerprints came from the same individual. Other types of biometric parameters are unique to an individual, and unchanging over time, and like fingerprints, provide a reliable static reference for comparison. Examples of such other types of static parameters include the pattern of blood vessels in the retina of the eye or in the finger or the pattern of friction ridges and depressions on the tongue of a person. When measured and stored, an exact match of the pattern of blood vessels in the retina or finger provides a highly reliable indication that the same retina or finger was measured in both instances.

While the comparison of static biometric parameters provides a fully satisfactory identification of individuals in highly controlled and/or monitored situations, the reliability of the identification can be compromised in less controlled environments, particularly if the individual whose biometric parameter was previously stored cooperates in an intentional scheme to conduct fraud. For example, in the delivery of insurer reimbursed medical services or equipment, fraud, while constituting a relative small percentage of the overall transactions, results in substantial economic losses. Since medical service transactions are conducted in a wide variety of physical locations and circumstances, including locations and circumstances that are not fully controlled, many of these transactions are susceptible to fraud.

Even with the magnitude of economic losses from fraudulent transactions, there is substantial pressure to insure that services and equipment are delivered only to authorized beneficiaries, even in the face of possible fraud. In many instances, the prevention of fraud requires accurate identification of an individual. For example, in the context of Medicare and or Medicaid transactions, it is important to accurately identify the individual receiving the services and/or equipment, and to insure that the individual receiving the services or equipment is an authorized beneficiary.

In one system for insuring the correct identify of an individual, a static biometric parameter, such as a fingerprint, is measured simultaneously with one or more dynamically variable parameters, such as pulse rate or oxygen saturation. The measured static parameter can be compared with an earlier measurement of the parameter, and used to insure that the individual whose fingerprint is being measured is an individual authorized to receive the benefits. The measured variable parameters can be used to insure that the individual supplying the fingerprint, or other static parameter, is the same individual receiving the service/equipment at the time the static parameter is being measured or who may later receive services, equipment or supplies where only the static parameter is measured. This latter objective is achieved by measuring the dynamically variable parameter in two locations: a first location adjacent to the fingerprint sensor, and a second location adjacent to a visually distinctive area of the individual, such the individual's face. A photograph of the individual's face along with a display of the dynamically variable parameters also is made simultaneously with the measurement of the static and variable parameters, and confirmation of an identification is achieved only when the fingerprint pattern corresponds to a previously recorded pattern of an authorized individual, and when the variable parameters, pulse and oxygen saturation in the example discussed above, are identical. The first location for sensing the dynamically variable parameters is chosen to be proximal to the fingerprint sensor, such as a location on the same hand from which the fingerprint is sensed, and the sensors are disposed in arrangements configured to make it difficult to simultaneously sense the fingerprint and variable parameter from different hands.

While the above described system is largely effective to prevent fraud, it remains subject to failure from a scheme in which an authorized beneficiary is successful in having his/her finger scanned by the fingerprint sensor while another person actually receives the services.

### SUMMARY OF THE INVENTION

In one embodiment of the invention, a device for simultaneously detecting both a unique static biometric identifier and a dynamic biometric variable of a human being includes a support structure configured to at least partially surround at least a portion of a single phalange of subject. A first sensor supported by the support structure for is used for sensing a static biometric identifier from a phlange, such as a fingerprint or pattern of blood vessels. The first sensor has an interface surface configured for placement in proximity to the phalange and is operative to capture a pattern of the phalange that uniquely identifies the human being. A second sensor also is supported by the support structure for placement on the same phlange in proximity to the first sensor. The second sensor is operative to detect a dynamically variable biometric parameter from the phalange of the human being at the same time the first sensor is capturing the unique pattern.

In another aspect of one embodiment of the invention, the first and second sensors are supported by the support structure in substantially perpendicular relationship to each other, and each of the first and second sensors sense biometric parameters from the phalange non-intrusively.

In another aspect of one embodiment of the invention, the second sensor includes first and second components with each of the first and second components having interfaces configured for placement in proximity to the single phalange and supported by the supporting structure in generally spaced relationship for placement on opposite sides of the single phalange.

In another aspect of one embodiment of the invention, the first and second components of the second sensor are supported by the supporting structure in a generally spaced relationship for placement at an oblique angle from each other.

According to an aspect of one embodiment, the apparatus includes a display associated with the support structure for displaying information representative of the dynamic biometric parameter being detected by the second sensor. The display is supported by the support structure in a predetermined spatial relationship to the first and second sensors.

In one embodiment of the invention, the display is supported by the support structure in a generally perpendicular relationship to an interface surface of the second sensor and is spaced in a generally parallel relationship to an interface surface of the first sensor so as to accommodate the insertion of a phalange between the first sensor and the display.

According to another aspect of one embodiment of the invention, the display and an interface surface of the first sensor are spaced by a distance configured to accommodate the insertion of a phalange between the display and the interface surface of the first sensor.

In one preferred aspect of one embodiment of the invention, the distance between the interface surface of the first sensor and the display is variable to accommodate variably sized phalanges.

In another embodiment, the support structure includes at least two relatively movable components that are configured to permit the insertion of the human phalange between the components.

In another embodiment, the support structure includes at least three relatively movable components, the components being configured to permit the insertion of the human phalange between the components.

In one exemplary embodiment, the first sensor captures an pattern image of a fingerprint of the phalange of a human being and the second sensor is a pulse oximeter.

According to another exemplary embodiment, a method of detecting both a unique static identifier and a dynamic biometric variable of a human being is provided. The method includes, beginning an identification session by inserting at least a portion of a phalange of a human being into a support structure, the support structure defining a generally cylindrically shaped opening for at least partially surrounding the portion of the human phalange; detecting the human being's oxygen saturation level; capturing the human being's fingerprint; displaying a randomly generated alpha-numeric on a display; and ending the detection the human being's oxygen saturation level and ending the identification session.

### BRIEF DESCRIPTION OF THE DRAWINGS

While the invention concludes with claims which particularly point out and distinctly claim the invention, it is believed the present invention will be better understood from the following description taken in conjunction with the accompanying drawings, in which like reference numbers identify the same elements in which:

FIG. 1 is a perspective view of a combined fingerprint pulse oximetry apparatus constructed in accordance with the principles of the present invention;

FIG. 2 is a side elevational view of a mounting block for mounting a pulse oximetry sensor in the apparatus depicted in FIG. 1, with a pair of sliding blocks in a non-deployed position;

FIG. 3 is a side elevational view of the mounting block depicted in FIG. 2 with the pair of sliding blocks in an expanded, deployed position;

FIG. 4 is plan view of the mounting block depicted in FIG. 3, showing the pair of sliding blocks in an expanded, deployed position;

FIG. 5 is a perspective view of the mounting block depicted in FIGS. 2-4, showing a pulse oximetry sensor mounted in the mounting block and the pair of sliding blocks in an expanded, deployed position;

FIG. 6 is a cross-sectional view of the combined fingerprint pulse oximetry apparatus of FIG. 1 depicting a fingerprint sensor mounted therein;

FIG. 7 is an exploded view showing the various components used in the apparatus of FIG. 1;

FIG. 8 is a perspective view of another embodiment of a combined fingerprint pulse oximetry apparatus constructed in accordance with the principles of the present invention;

FIG. 9 is a perspective view of another embodiment of a combined fingerprint pulse oximetry apparatus depicting the support structure with at least three relatively movable components;

FIG. 10 is a perspective view of another embodiment of a combined fingerprint pulse oximetry apparatus depicting the support structure with at least three relatively movable components and

FIG. 11 is a side elevational view of another embodiment of a combined fingerprint pulse oximetry apparatus depicting the support structure with mounting blocks and at least three relatively movable components.

Reference will now be made in detail to certain exemplary embodiments of the invention, examples of which are illustrated in the accompanying drawings.

### DETAILED DESCRIPTION

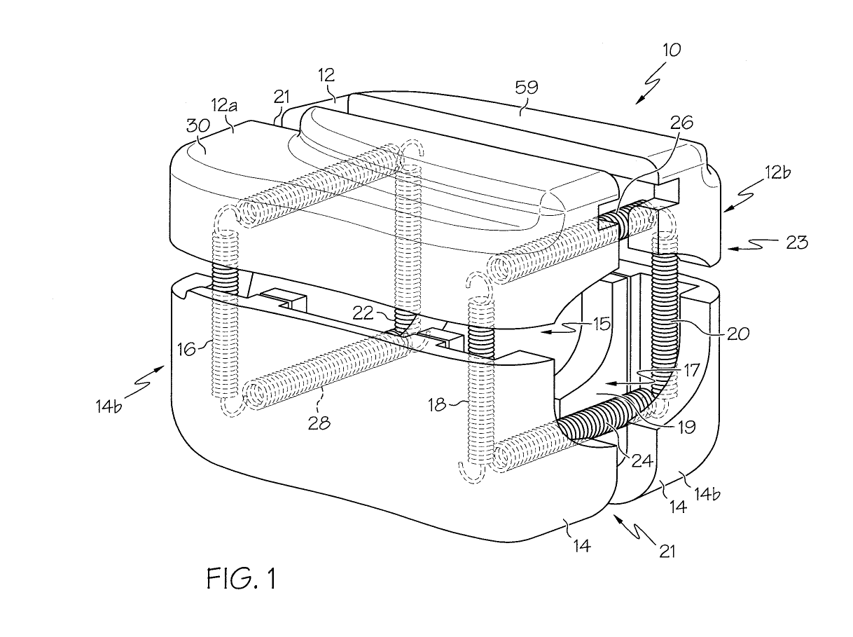

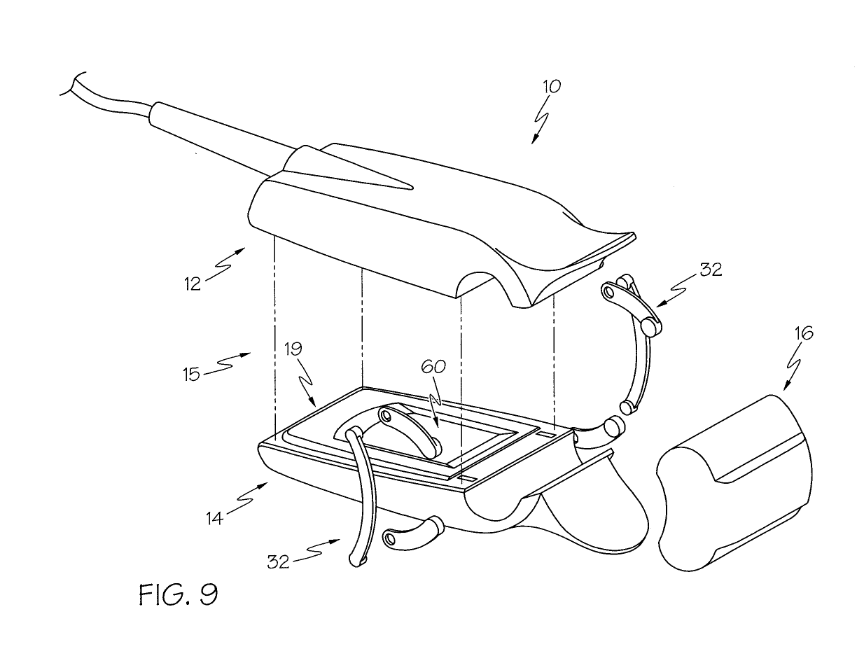

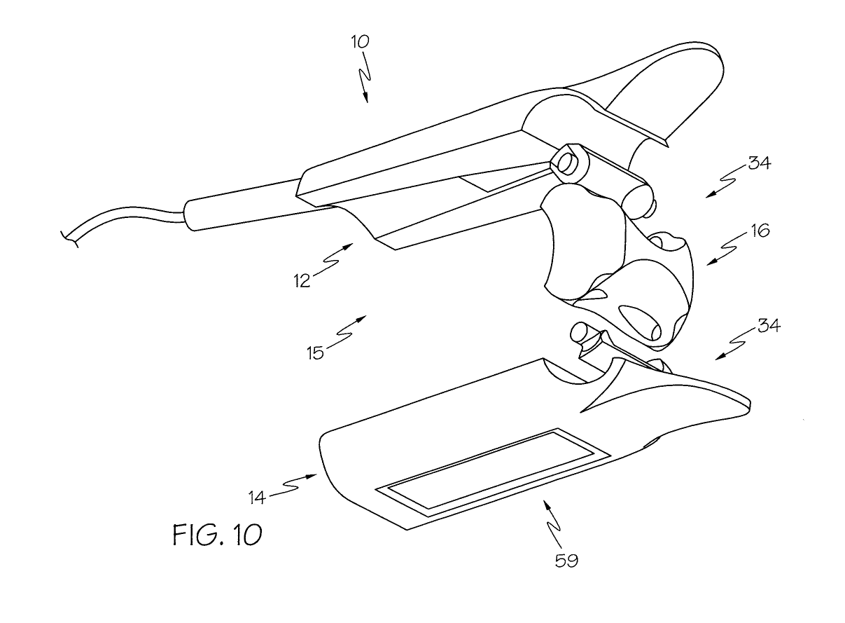

Referring now to the drawings, FIG. 1 shows a perspective view of one embodiment of a sensing apparatus, generally designated in the drawings by the numeral 10, constructed in accordance with the principles of the present invention. In one exemplary embodiment, as illustrated in FIG. 1, the sensing apparatus 10 includes upper and lower housing components 12 and 14 respectively for supporting a plurality of sensors, as described in greater detail below. In another exemplary embodiment, as illustrated in FIGS. 9 and 10, the sensing apparatus 10 includes upper, lower and front housing components 12, 14 and 16, respectively, for supporting a plurality of sensors, as described in greater detail below. The components 12 and 14 cooperate to define an opening 15 on one end (the right hand side as viewed in FIG. 1 and the left hand side as viewed in FIGS. 9 and 10) of the sensing apparatus 10 to accommodate a phlange, such as a finger, of a human or other test subject. In one exemplary embodiment, as depicted in FIG. 1, the opening 15 is formed of arcuate cutaways in the ends of housing components 12a, 12b, 14a and 14b, which cutaways jointly form a generally circular opening into the sensing apparatus 10. The lower portion of the opening 15 generally aligns with an arcuate surface 17 of a finger support structure at 19 (shown more clearly in FIG. 7). In yet another exemplary embodiment, as depicted in FIG. 10, the opening 15 is formed of arcuate cutaways in the ends of housing components 12 and 14, which cutaways jointly form a generally circular opening into the sensing apparatus 10.

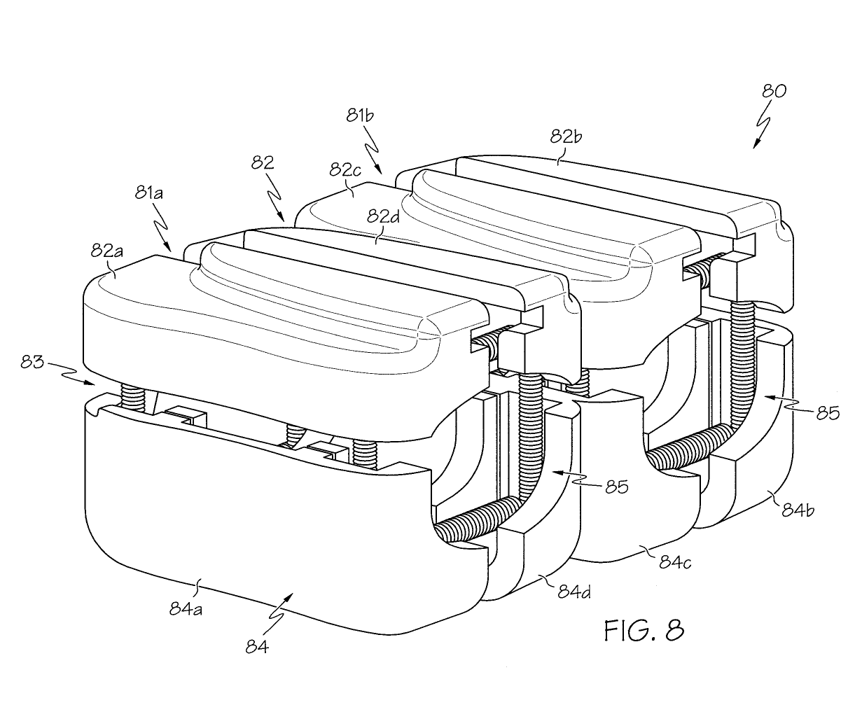

In order to accommodate fingers of different sizes, the housing components 12 and 14 are moveable relative to each other. In one exemplary embodiment, as depicted in FIG. 1, each of the housing components 12 and 14 includes a pair of relatively movable sub-components, housing component 12 having sub-components 12a and 12b, and housing component 14 having sub-components 14a and 14b. Housing components 12a and 12b are structurally in the interval and movable relative to each other. They are separated by a vertical divide or discontinuity 21, which discontinuity 21 allows the sensing apparatus 10 to expand horizontally on tracks along the x-axis. As emphasized in the depiction of FIG. 1, the housing components 12 and 14 are resiliently secured together by a plurality of vertically oriented (as illustrated in FIG. 1) springs. However, it will be understood that any device configured to expand may be used without departing from the scope of the present invention. Specifically, springs 16 and 18 and 20 and 22 (spring 22 is obscured in FIG. 1, see FIG. 6) extend between components 12 and 14, and resiliently secure those housing components together. The springs 16, 18, 20 and 22 are extendable, and allow the components 12 and 14 to expand vertically, when necessary, to accommodate a finger of a subject whose biometric parameters are being measured by the sensing apparatus 10. Extension springs 24 and 26, and 28 and 30, respectively extend between housing sub-components 12a and 12b and 14a and 14b to allow horizontal expansion between the sub-components of housing components 12 and 14 along the x-axis. However, although springs 24, 26, 28 and 30 are depicted in FIG. 1, it will be understood that any device configured to expand may be used without departing from the scope of the present invention. A horizontal divide or discontinuity 23 between the housing components 12 and 14 allows the sensing apparatus 10 to expand along to y-axis to accommodate differing finger thickness. Thus, in a manner analogous to the vertical expansion permitted by springs 16, 18, 20 and 22, the springs 24, 26, 28 and 30 allow horizontal expansion, when necessary, to accommodate a finger of a subject whose biometric parameters are being measured. The opening 15 of one exemplary embodiment is sized and designed to fit a typical finger of an infant. However, it will be understood that the springs and track mechanism allow for sufficient vertical and horizontal expansion of the housing to fit any finger of varying thickness and width, including, for example, children, teenagers and adults. The springs optimally are selected to exert the appropriate amount of pressure to ensure that the biometric sensors (described below) are held in place against the inserted finger to prevent slippage. The springs 16, 18, 20, 22, 24, 26, 28 and 30, of course, urge the housing back to the position illustrated in FIG. 1 when a finger requiring expansion of the opening 15 is removed.

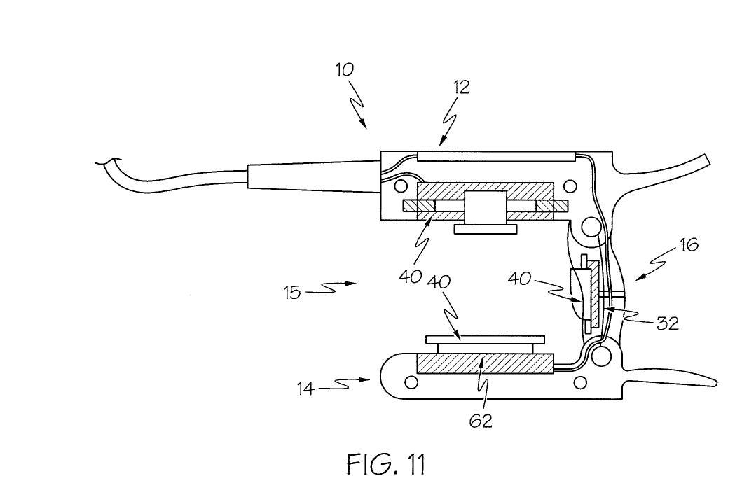

In yet other embodiments, as depicted in FIGS. 9 and 11, fingers of different sizes can be accommodated by expansion units 32. As emphasized in the depiction of FIGS. 9 and 11, the expansion units 32 extend between components 12 and 14, and resiliently secure those housing components together. Although illustrated in FIG. 11 as a spring, it will be understood that any device configured to expand may be used without departing from the scope of the present invention. The expansion units 32 are extendable, and allow the components 12 and 14 to expand vertically, when necessary, to accommodate a finger of a subject whose biometric parameters are being measured by the sensing apparatus 10. In one exemplary embodiment, the expansion units 32 are extendable such that components 12 and 14 are moveable to each other in a parallel relationship.

In yet another embodiment, as depicted in FIG. 10, fingers of different sizes can be accommodated by pivot members 34. As emphasized in the depiction of FIG. 10, the pivot members 34 are positioned between components 12 and 14, and pivot to allow the components 12 and 14 to expand vertically, when necessary, to accommodate a finger of a subject whose biometric parameters are being measured by the sensing apparatus 10.

In the embodiment illustrated in FIGS. 1, 9, 10 and 11, the sensing apparatus 10 simultaneously senses multiple biometric parameters from a single finger of a subject. In these illustrated exemplary embodiment, the sensing apparatus 10 senses a subject's fingerprint, pulse and oxygen saturation. Pulse and oxygen saturation are measured in the illustrated embodiment by a transmission type pulse oximeter. However, it will be understood that any known device configured to measure a person's pulse and oxygen saturation may be used without departing from the scope of the present invention. For example, in one embodiment a reflectance type pulse oximeter may be used. In transmission type pulse oximeter an emitter emits red and infrared radiation through a finger or other body part, and a photodetector, positioned on opposite sides of a finger, receives light that passes through the finger. Since oxygenated hemoglobin absorbs more infrared light and allows more red light to pass through, and deoxygenated hemoglobin absorbs more red light and allows more infrared light to pass through, the ratio of red to infrared light received by the photodetector is proportional to the amount of oxygen in the hemoglobin, and this ratio can be used to measure the amount of oxygen in the blood. When a finger or other body part is placed between the emitter and photodetecter, light is absorbed by the skin, tissue and arterial blood. The light absorption of the skin and tissue is constant, while the absorption of light by the arterial blood is variable, as the amount of arterial blood varies with each beat of the heart. Hence, it is possible not only to account for the amount of absorption by components of the finger other than arterial blood, such as skin, tissue, etc., but also determine the pulse of individual. By accounting for light absorption from sources other than arterial blood, and using the ratio of red and infrared absorption, both pulse and oxygen saturation of the blood can be determined.

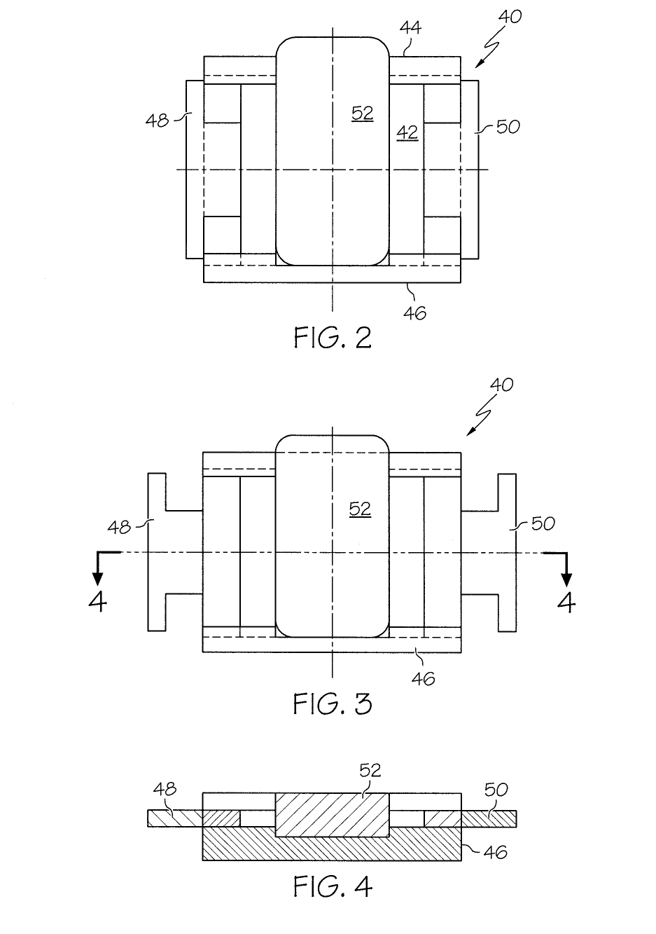

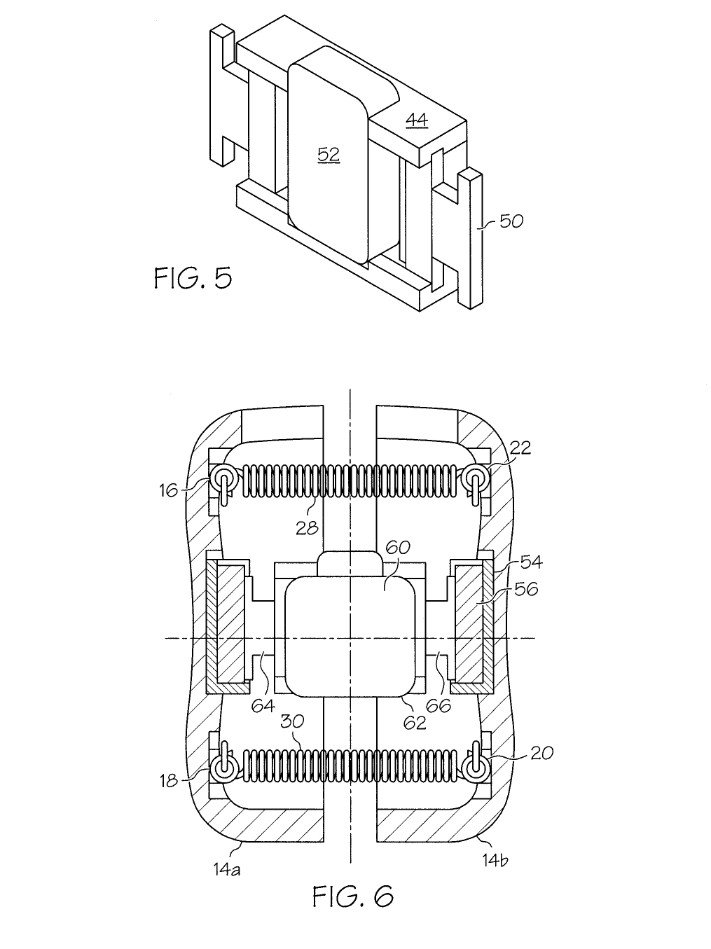

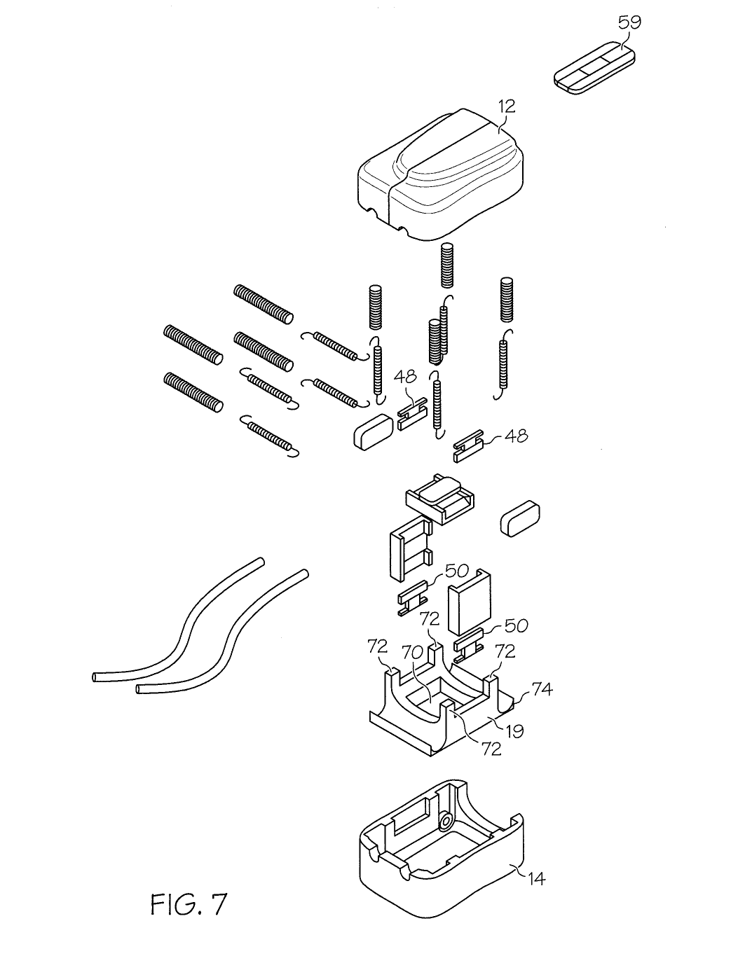

In the exemplary embodiment illustrated in FIG. 2, the emitter and photodetector are supported on sliding blocks, such as rail block 40. The rail block 40 includes a central body portion 42 with rails 44 and 46 extending vertically at its sides. The rails 44 and 46 support sliding blocks 48 and 50, which sliding blocks 48 and 50 slidingly interconnect the rail block 40. In one embodiment, as illustrated in FIG. 1, the sliding blocks 48 and 50 slidingly interconnect the rail block 40 to the upper and lower housing components 12a and 14a. The illustrated central body 42, in turn, supports an emitter 52 of a pulse oximeter. A further rail block 54 (partially obscured in FIG. 1, see FIG. 6) is disposed between housing sub-components 12b and 14b. The rail block 54 further includes sliding blocks that otherwise are identical to sliding blocks 48 and 50, but which interconnect the rail block 54 to housing sub-components 12b and 14b, and which support a photodetecter 56, as depicted in FIG. 6, instead of the emitter 52. As shown in the embodiment illustrated in FIG. 2, sliding blocks 48 and 50 are in a retracted position corresponding to the non-expanded position of the housing illustrated in FIG. 1. FIGS. 3, 4 and 5, on the other hand, show the rail block 40 with the sliding blocks 48 and 50 in an extended deployed position corresponding to the expansion of the housing along the y-axis. As such, it will be understood, that a apparatus configured in such a manner will enable housing components 12 and 14 to be movable in at least two directions along perpendicular axis. Slidingly supporting the emitter and 52 in the photodetector 56 in this manner allows the emitter 52 and photodetector 56 to remain stationary and optimally positioned relative to the finger support structure 19 to facilitate precise readings for the pulse oximeter. These readings are displayed on an alpha-numeric display 59 positioned at the top of the sensing apparatus 10. As illustrated in FIG. 1 and more clearly depicted in FIG. 7, an alpha-numeric display 59 may be fitted in slots in housing components 12a and 12b. The slots allow the alpha-numeric display 59 to remain at the center of the sensing apparatus 12 when an insertion of a finger that causes the expansion along the x-axis and/or y-axis occurs. In some embodiments, it will be understood that the alpha-numeric display 59 could randomized digits and letters generated by the apparatus 10 or, in still other embodiments, generated by a source external to the apparatus 10, such as a computer.

In another embodiment, as illustrate in FIG. 11, the rail block 40, as detailed above, may be included in the upper, lower and front housing components 12, 14 and 16. However, it will be understood that, in other embodiments, the rail block 40 may be included in only one or two of the housing components. In one embodiment, the emitter 52 and photodetector 56 may be included in the upper and front housing components 12 and 16, respectively. In another embodiment, the fingerprint sensor 60 may be included in the lower housing component 14. It will be also understood that the further embodiments and components detailed herein with regard to the sensing apparatus 10, such as housing components 12 and 14, rail block 40 and rail member 62, illustrated in FIGS. 1-10 can be equally used and configured for the sensing apparatus 10, such as housing components 12 and 14, rail blocks 40 and rail member 62, illustrated in FIG. 11.

In the exemplary embodiments illustrated in FIGS. 9-11, the emitter and photodetector are supported on components 12 and 16, respectively. It will be understood that the emitter and 52 the photodetector 56 are supported in a manner that allows the emitter 52 and photodetector 56 to remain stationary and optimally positioned relative to the finger support structure 19 to facilitate precise readings for the pulse oximeter. In one embodiment, the emitter and 52 the photodetector 56 are generally in a spaced relationship and form an oblique angle between each other. These readings are displayed on an alpha-numeric display 59 positioned at the top of the sensing apparatus 10. As illustrated in FIG. 10, an alpha-numeric display 59 may be fitted in housing component 14. In some embodiments, it will be understood that the alpha-numeric display 59 could randomized digits and letters generated by the apparatus 10 or, in still other embodiments, generated by a source external to the apparatus 10, such as a computer.

The sensing apparatus 10 further includes a fingerprint sensor 60, as shown in FIGS. 6, 9 and 11. In one embodiment, as depicted, for example, in FIGS. 6 and 11, the fingerprint sensor 60 is supported on a rail member 62, which rail member slidingly receives rails 64 and 66. The sliding engagement between the rail member 62 and rails 64, 66 permits the fingerprint sensor 60 to remain centrally located when the housing subcomponents 14a and 14b are expanded to accommodate a larger finger size. In another embodiment, as depicted in FIG. 9, the fingerprint sensor 60 is supported on component 14.

As jointly shown in FIGS. 1 and 7, the finger support structure 19 includes a centrally disposed cavity 70 for accommodating the rail member 62 of the fingerprint sensor 60. It further includes four upwardly extending guide members 72 for providing lateral support for the rails (such as rails 44 and 46) of the rail blocks for the emitter 52 and photodetector 56. The finger stop 74 is provided on the finger support structure 19 so that inserted finger is properly positioned in relation to the fingerprint sensor 60, emitter 52 and photodetector 56 to facilitate accurate readings for those sensors.

It will be appreciated that the emitter 52 and photodetector 56 are positioned to measure read and infrared absorption at the end of an inserted finger adjacent to the fingerprint sensor 60. Unlike the typical pulse oximeter, the emitter 52 and photodetector 56 can be positioned on opposite sides or at the top and tip of the inserted finger, rather than at the top and bottom of the finger, as is more typical. This allows the fingerprint sensor 60 to be positioned at the bottom of the finger, at the location of the friction ridges at the bottom of the finger. This enmity between the fingerprint sensor 60 and pulse oximeter is achieved in the exemplary embodiment illustrated by placing the emitter 52 and photodetector 56 in a substantially perpendicular relationship, as depicted in FIG. 1, or at an oblique angle relative to each other, as depicted in FIGS. 9 and 10, to the fingerprint sensor 60. It will be appreciated, however, that other arrangements within the scope of the invention are possible. For example, if the static biometric parameter measured by the sensing apparatus is a pattern of blood vessels in the finger, rather than a fingerprint, the static biometric parameter can be measured from the sides of the finger. In that situation, for example, the emitter 52 and photodetector 56 of the pulse oximeter could be positioned at the top and bottom of the fingertip.

In use, for example, a physician or other healthcare care professional, may began an identification session by inserting the person's (i.e., who is being identified) finger into the opening 15. At which point, the emitter 52 and photodetector 56 of the pulse oximeter may begin to cooperate with each other to start detecting the person's oxygen saturation level. Next, the fingerprint sensor 62 may capture the person's fingerprint and a randomly generated alpha-numeric may be displayed on the display 59. The pulse oximeter may stop detecting the person's oxygen saturation level and, at which point, the physician or other healthcare care professional may end the identification session. Lastly, the data, including the fingerprint, alpha-numeric and pulse-oximeter data may be stored on the oximeter or an external device, such as a computer, and/or it may be transmitted to an external device, such as a computer by any means known in the art, such as via Bluetooth.

As shown in the embodiment illustrated in FIG. 8, the sensing apparatus 80 may be configured to accommodate two phlanges, such as fingers, of a human or other test subject. Although the sensing apparatus 80 is illustrated in FIG. 8 to only allow for two fingers, it will be understood that the sensing apparatus can be configured to accommodate any amount of fingers without departing from the scope of the present invention. Referring now to FIG. 8, the sensing apparatus 80 includes upper and lower housing components 82 and 84 respectively for supporting a plurality of sensors. The components 82 and 84 cooperate to define openings 85 on one end (the right hand side as viewed in FIG. 8) of the sensing apparatus 80 to accommodate the two fingers of the person. The openings 85 are formed of arcuate cutaways in the ends of housing components 82a, 82b, 82c, 82d, 84a, 84b, 84c and 84d, which cutaways jointly form a generally circular opening into the sensing apparatus 80.

In order to accommodate fingers of different sizes, each of the housing components 82 and 84 includes a plurality of relatively movable sub-components, housing component 82 having sub-components 82a, 82b, 82c and 82d, and housing component 84 having sub-components 84a, 84b, 84c and 84d. Housing sub-components 82a, 82b, 82c and 82d and sub-components 84a, 84b, 84c and 84d are structurally in the interval and movable relative to each other. However, it will be understood that in some embodiments, sub-components 82a, 82d, 84a and 84d be configured to be movable independent of sub-components 82b, 82c, 84b and 84c. As illustrated in FIG. 8, sub-components 82a and 82d and sub-components 82b and 82c are separated by vertical divides or discontinuities 81a and 81b, which discontinuities 81a and 81b allow the sensing apparatus 80 to expand horizontally on tracks along the x-axis. As also illustrated in FIG. 8, sub-components 84a and 84d and sub-components 84b and 84c are separated by vertical divides or discontinuities 81a and 81b, which discontinuities 81a and 81b also allow the sensing apparatus 80 to expand horizontally on tracks along the x-axis As also illustrated in FIG. 8, a horizontal divide or discontinuity 83 between the housing components 82 and 84 allows the sensing apparatus 80 to expand along to y-axis to accommodate differing finger thickness.

It will be also understood that the further embodiments and components detailed above with regard to the sensing apparatus 10 illustrated in FIGS. 1-7, 9 and 10 can be equally used and configured for the sensing apparatus 80. In particular, in one embodiment the sensing apparatus 80 may be configured to accommodate two pulse oximeters and two fingerprint sensors such that pulse, oxygen saturation and a fingerprint may be sensed from each finger. In yet another embodiment the sensing apparatus 80 may be configured to accommodate only one pulse oximeter and one fingerprint sensor such that pulse and oxygen saturation may be sensed from one finger and a fingerprint sensed from the other. However, it will be understood that any configuration may be used without departing from the scope of the present invention.

Advantageously, the sensors used by the exemplary embodiment illustrated are totally noninvasive. That is, neither the static barometric parameter (fingerprint) nor the dynamically variable biometric parameter (oxygen saturation, pulse) mechanically penetrate the finger. Similarly, none of the sensors require insertion into a body cavity or an incision into the body.

The foregoing description of the preferred embodiments of the present invention have been presented for purposes of illustration and description. It is not intended to be exhaustive or to limit the invention to the precise form disclosed. Obvious modifications or variations are possible in light of the above teachings. The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way.

What is claimed is:

1. A device for simultaneously detecting both a unique static biometric identifier and a dynamic biometric variable of a human being, comprising:
a support structure configured to at least partially surround at least a portion of a single phalange of subject;
a first sensor supported by the support structure for sensing a static biometric identifier from the single phlange, the first sensor having an interface surface configured for placement in proximity to the phlange and being operative to capture a pattern of the phlange that uniquely identifies the human being; and
a second sensor supported by the support structure for placement on the single phlange in proximity to the first sensor, the second sensor being operative to detect a dynamically variable biometric parameter from the phalange of the human being at the same time the first sensor is capturing the unique pattern.

2. A device as recited in claim 1, wherein the first and second sensors are supported by the support structure in substantially perpendicular relationship to each other.

3. A device as recited in claim 2, wherein each of the first and second sensors sense biometric parameters from the phalange non-intrusively.

4. A device as recited in claim 3, wherein the second sensor includes first and second components with each of the first and second components having interfaces configured for placement in proximity to the single phalange and supported by the supporting structure in generally spaced relationship for placement on opposite sides of the single phalange.

5. A device as recited in claim 1, further including a display associated with the support structure for displaying information representative of the dynamic biometric parameter being detected by the second sensor.

6. A device as recited in claim 5, wherein the display is supported by the support structure.

7. A device as recited in claim 6, wherein the display is supported in a predetermined spatial relationship to the first and second sensors.

8. A device as recited in claim 7, wherein the display is supported by the support structure in a generally perpendicular relationship to an interface surface of the second sensor and is spaced in a generally parallel relationship to an interface surface of the first sensor so as to accommodate the insertion of a phalange between the first sensor and the display.

9. A device as recited in claim 7, wherein the display and an interface surface of the first sensor are spaced by a distance configured to accommodate the insertion of a phalange between the display and the interface surface of the first sensor.

10. A device as recited in claim 9, wherein the distance between the interface surface of the first sensor and the display is variable to accommodate variably sized phalanges.

11. A device as recited in claim 1, wherein the support structure includes at least two relatively movable components, the components being configured to permit the insertion of the human phalange between the components.

12. A device as recited in claim 11, wherein the two relatively movable components of the support structure are pivotably movable relative to each other about a pivotal axis.

13. A device as recited in claim 12, wherein the pivotal axis is resiliently biased to a first position.

14. A device as recited in claim 13, wherein the pivotal axis is movable from the first position against the resilient bias to increase the distance between the first and second components and to accommodate phalanges of variable size between the first and second components.

15. A device as recited in claim 1, wherein the first sensor captures a pattern image of a fingerprint of the phalange of the human being.

16. A device as recited in claim 1, wherein the second sensor is an oximeter.

17. A device as recited in claim 1, wherein the second sensor monitors a pulse from the phalange of the human being.

18. A device as recited in claim 1, wherein the second sensor includes first and second components with each of the first and second components having interfaces configured for placement in proximity to the single phalange.

19. A device as recited in claim 18, wherein the first and second components are supported by the supporting structure in a generally spaced relationship for placement at an oblique angle from each other.

20. A device as recited in claim 18, wherein the support structure includes at least three relatively movable components, the components being configured to permit the insertion of the human phalange between the components.

21. A device as recited in claim 20, wherein the first and third support structure components are positioned substantially parallel to each other and the second support structure component is positioned substantially perpendicular to the first and third support structure components.

22. A device as recited in claim 21, wherein the first component of the second sensor is positioned on the first support structure component and the second component of the second sensor is positioned on the second support structure component.

23. A device for simultaneously detecting both a unique static identifier and a dynamic biometric variable of a human being, comprising:
a support structure, the support structure defining a generally cylindrically shaped opening for at least partially surrounding a portion of a human phalange;
a first sensor supported by the support structure at a first location, the first sensor being operative to capture a pattern of the phalange that uniquely identifies the human being; and
a second sensor supported by the support structure at a second location angularly spaced from the first location by approximately 90 degrees about the periphery of the opening, the second sensor being operative to detect a dynamically variable biometric parameter from the phalange of the human being at the same time the first sensor is capturing the unique pattern.

24. A method of detecting both a unique static identifier and a dynamic biometric variable of a human being, comprising
beginning an identification session by inserting at least a portion of a phalange of a human being into a support structure, the support structure defining a generally cylindrically shaped opening for at least partially surrounding the portion of the human phalange;
detecting the human being's oxygen saturation level;
capturing the human being's fingerprint;
displaying a randomly generated alpha-numeric on a display;
ending the detection the human being's oxygen saturation level; and
ending the identification session.
